(19) United States
(12) Patent Application Publication
(10) Pub. No.: US 2025/0248394 A1
(43) Pub. Date: Aug. 7, 2025

(54) HERBICIDAL EODE FORMULATION COMPRISING SEVERAL ACTIVE INGREDIENTS

(71) Applicant: BASF AGRO B.V., Arnhem (NL)

(72) Inventors: Claude Taranta, Limburgerhof (DE); Felix Salvadore Hoffmann, Ludwigshafen (DE); Douglas Findley, Research Triangle Park, NC (US); Ryan Nielson, Durham, NC (US); Steven Joseph Bowe, Research Triangle Park, NC (US)

(21) Appl. No.: 18/856,942

(22) PCT Filed: Jul. 3, 2023
(86) PCT No.: PCT/EP2023/068225

§ 371 Date: Oct. 15, 2024

(30) Foreign Application Priority Data
Jul. 13, 2022 (EP) 22184608.2

(51) Int. Cl. A01N 25/04; A01N 43/50; A01N 43/54; A01N 43/80; A01N 43/84; A01P 13/00

(52) U.S. Cl. CPC A01N 25/04; A01N 43/50; A01N 43/54; A01N 43/80; A01N 43/84; A01P 13/00

(57) ABSTRACT

The invention relates to an agrochemical formulation comprising a continuous oil phase comprising a water-immiscible solvent; four agrochemical actives, Saflufenacil, Trifludimoxazin, Pyroxasulfone and Imazethapyr, in the form of particles, which particles are suspended in the continuous oil phase; and water droplets that are emulsified in the continuous oil phase, wherein the agrochemical formulation is substantially free of a thickener. It also relates to a method for preparing the agrochemical formulation and to a method of use of the agrochemical formulation.

In crop protection, it is generally desirable to increase the specificity and the reliability of the action of active compounds. In particular, it is desirable for crop protection products to control the harmful plants effectively and, at the same time, to be well tolerated by the respective crop. In addition, the crop protection product must meet strict requirements concerning the stability of the formulation, which should also allow for safe and convenient handling by the farmer.

A large number of different herbicidally active compounds is available to address specific requirements for weed control. Sometimes it is necessary or advisable to combine two or more active ingredients to achieve the desired activity.

Many agrochemical actives are formulated as liquid concentrates. If the agrochemical active is not soluble in the liquid, it is often necessary to form a stable and homogeneous suspension of the agrochemical active in the continuous liquid phase. If the continuous liquid phase is an aqueous phase, these formulations are known in the art as suspension concentrates (SCs). If the continuous liquid phase is an oil phase, these formulations are known as oil dispersions (ODs). It is desirable that the applicant does not need to homogenize the liquid concentrate before use, since this will require additional time and handling, including exposure to potentially toxic ingredients that may be present in the agrochemical formulation. A major problem for suspensions of particles is that the particles tend to form sediment over time by particle growth and/or settling of the particles. This tendency may be accompanied by caking of the sediment, i.e. the formation of solid sediment that cannot be easily resuspended by the applicant.

To prevent the formation of sediment (and particle-free serum in the supernatant), thickeners are generally added to suspension concentrates and oil dispersions. The thickeners increase the viscosity of the continuous liquid phase, which reduces the influence of gravitational sedimentation and particle-particle interactions in the suspension.

OD formulations are advantageous as compared to SC formulation in that no expensive biocides, many of those being under regulatory scrutinization (e.g. BIT, MIT, CIT) are required to protect the formulation from infestation by microorganisms and fungi. Unfortunately, the majority of thickeners is not compatible with the continuous oil phases of OD formulations. Either they are not soluble or cannot be activated, in other words, are not able to unfold their thickening and/or suspending properties in the lipophilic environment of the continuous oil phases. Other thickeners that are especially designed for lipophilic solvents are often expensive and may interact disadvantageously with other additives or the active ingredients in the formulation. Since oil dispersions are typically applied by dilution in an aqueous tank mix composition by farmers, it is also not only required that the thickener is soluble in the oil phase of the OD formulation, but that they do not create any problems during dilution with water (e.g. by precipitation).

EODE formulations comprising a single active ingredient were described in WO2020126508. However, these formulations may not be sufficient to effectively control a broader range of different weed species.

It is thus desirable to find formulations that overcome the problems associated with either combining several active ingredients into one formulation or with tank mixing several herbicidal products. On the one hand, active ingredients have different chemical stability in water at a certain pH (ease of storage (shelf life)). On the other hand, tank mixing can cause issues with the compatibility of different formulations, adequate activity in weed control, and handling.

These and further objectives are achieved by the formulations defined below.

Accordingly, the present invention provides agrochemical formulations comprising
a) a continuous oil phase comprising a water-immiscible solvent;
b) four agrochemical actives, Saflufenacil, Trifludimoxazin, Pyroxasulfone and Imazethapyr, in the form of particles, which particles are suspended in the continuous oil phase;
c) a dispersant, which is an alkoxylated fatty acid ester; and
d) water droplets that are emulsified in the continuous oil phase;
wherein the agrochemical formulation is substantially free of a thickener.

It has now surprisingly been found that said EODE formulation, which is stabilized by emulsified water droplets in the continuous oil phase, and comprises four different active ingredients is equal or more effective in controlling weeds than a tank mix of said active ingredients formulated separately and shows excellent storage stability.

The present invention also provides a method for preparing the agrochemical formulation.

The present invention also provides a method for controlling undesired plant growth by applying said agrochemical EODE formulation.

Preferred embodiments are described in the specification and the claims. Combinations of embodiments with other embodiments are within the scope of the disclosure.

The invention relates to an agrochemical EODE formulation, comprising four active ingredients.

Saflufenacil is the common name of the compound 2-chloro-5-[3,6-dihydro-3-methyl-2,6-dioxo-4-(trifluoromethyl)-1-(2H)pyrimidinyl]-4-fluoro-N-[[methyl (1-methylethyl)amino]sulfonyl]benzamide, which is a herbicidally active compound, inhibiting the plant enzyme protoporphyrinogen oxidase (PPO). Saflufenacil has been described in WO2001/083459. Further processes for its preparation are described in WO2003/097589, WO2005/054208, WO2006/097589, WO2006/125746 and WO2008/043835. Saflufenacil is particularly useful for preplant applications and selective preemergence weed control in multiple crops, including corn and soybean. Saflufenacil as described herein includes also different forms of the compound, such as crystalline or particle forms, as described for example in WO200843835, WO200843836 or WO201737210.

Trifludimoxazin is the common name for the compound 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione, which is also a herbicidally active compound, inhibiting the plant enzyme protoporphyrinogen oxidase (PPO). Trifludimoxazin, a process for its production and compositions comprising Trifludimoxazin are known from WO2010/145992. Trifludimoxazin as described herein includes also different forms of the compound, such as crystalline or particle forms. WO2013/174693 discloses crystalline form A of Trifludimoxazin, WO2013/174694 discloses crystalline form B. WO2015/071087 discloses compositions comprising a particle form of Trifludimoxazin, wherein at most 50% per volume of the particles have a diameter below 3 μm.

Pyroxasulfone is the common name for the compound 3-[[[5-(difluoromethoxy)-1-methyl-3-(trifluoromethyl)-1H-pyrazol-4-yl]methyl]sulfonyl]-4,5-dihydro-5,5-dimethylisoxazole, which is also a herbicidally active compound, inhibiting the biosynthesis of very-long-chain fatty acids (VLCFAs). Pyroxasulfone, a process for its production and compositions comprising Pyroxasulfone were described in WO2002/062770, WO2004/014138 and W2000/8075743.

Imazethapyr is the common name for the compound 2-[4,5-dihydro-4-methyl-4-(1-methylethyl)-5-oxo-1H-imidazol-2-yl]-5-ethyl-3-pyridinecarboxylic acid, which inhibits the plant enzyme acetolactate synthase (ALS). Imazethapyr is an active compound from the group of imidazolinone herbicides, which are known e.g. from Shaner, D. L., O′ Conner, S. L, The Imidazolinone Herbicides, CRC Press Inc., Boca Raton, Florida 1991. Where reference is made to Imazethapyr, this includes the free acid as well as agriculturally acceptable salts thereof. Examples of agriculturally acceptable salts of Imazethapyr include alkaline or earth alkaline metals or ammonium or organoammonium salts, for instance, sodium, potassium, ammonium and isopropyl ammonium. Particularly preferred is imazethapyr ammonium salt. Reference to a salt includes the anhydrous form as well as hydrated forms thereof.

Each of the active ingredients Saflufenacil, Trifludimoxazin, Pyroxasulfone and Imazethapyr is present as particles suspended in the continuous oil phase.

The agrochemical formulation contains a continuous oil phase. The term “continuous oil phase” is known in the technical field of dispersions and refers to the dispersion medium in which particles or liquids are distributed in. In the present case, the continuous oil phase relates to the liquid in which both the water droplets and the agrochemical actives are dispersed in.

The continuous oil phase comprises a water-immiscible solvent. The water immiscible solvent typically has a water-solubility of up to 50 g/l, preferably up to 20 g/l, more preferably up to 10 g/l, most preferably up to 1 g/l, and especially preferably up to 0.5 g/l at 20° C.

Suitable examples for water-immiscible solvents are a hydrocarbon solvent such aliphatic, cyclic and aromatic hydrocarbons (e. g. toluene, xylene, paraffin, tetrahydronaphthalene, alkylated naphthalenes or their derivatives, mineral oil fractions of medium to high boiling point (such as kerosene, diesel oil, coal tar oils)); vegetable oils, such as corn oil, rapeseed oil; fatty acid esters such as C₁-C₁₀-alkylester of a C₁₀-C₂₂-fatty acid; or methyl- or ethyl esters of vegetable oils such as rapeseed oil methyl ester or corn oil methyl ester. Mixtures of aforementioned solvents are also possible. In one embodiment, the water-immiscible solvent is a vegetable oil. In another embodiment, the solvent is a hydrocarbon. In another embodiment, the water-immiscible solvent is a fatty acid ester. Particularly preferred water-immiscible solvents are soybean oil, methylated soybean oil, hydrocarbon solvents selected from aliphatic and cyclic hydrocarbons, or mixtures thereof.

The most preferred water-immiscible solvent is methylated soybean oil (MSO, soybean oil methyl ester, e.g. Surfom EMS 2000, Steposol SB-W or Agnique ME 18 SD-F). The continuous oil phase, in particular the water-insoluble solvent contained therein, may also function as a biological adjuvant for the agrochemical active, i.e. the biological efficacy of the agrochemical active may be increased by the continuous oil phase.

The agrochemical formulation typically contains at least 20 wt % of the water-immiscible solvent, preferably at least 30 wt %, more preferably at least 40 wt %, most preferably at least 50 wt % based on the total weight of the agrochemical formulation. The agrochemical formulation may contain up to 95 wt % of the water-immiscible solvent, preferably up to 90 wt %, more preferably up to 85 wt %, most preferably up to 70 wt %, and especially preferably up to 60 wt %. Typically, the agrochemical formulation contains the water-immiscible solvent in a concentration of from 10 to 95 wt %, preferably of from 20 to 80 wt %, more preferably of from 30 to 60 wt % based on the total weight of the agrochemical formulation.

The continuous oil phase may comprise additional water-soluble solvents. The term “water-soluble solvents” does not comprise water per se and refers to organic solvents that have a certain solubility in water. The water-solubility of these additional solvents may be at least 50 g/l, preferably at least 100 g/l, more preferably at least 150 g/l, most preferably at least 200 g/l at 20° C. Typical water-soluble solvents are propylene carbonate, dimethylcarbonate, ethylene carbonate, acetone, gamma-butyrolactone, tetrahydrofuran, N-methyl-2-pyrrolidon, acetonitrile, nitromethane, dimethyl formamide, dimethylacetamide, dimethylsulfoxide, sulfolane, and alcohols such as methanol, ethanol and isopropanol. Typically, the agrochemical formulation does not contain any additional water-soluble solvents. In one embodiment, the agrochemical formulation contains less than 10 wt %, preferably less than 1 wt %, more preferably less than 0.1 wt % of an additional water-soluble solvent based on the total weight of the total weight of the agrochemical formulation.

The agrochemical formulation contains four agrochemical actives, Saflufenacil, Trifludimoxazin, Pyroxasulfone and Imazethapyr. The term “agrochemical active” refers to a compound that confers a desirable biological activity to the agrochemical formulation. Typically, the agrochemical active is a pesticide.

The agrochemical formulation according to the invention may additionally comprise at least one further agrochemical active. The further agrochemical actives may be selected from fungicides, insecticides, nematicides, herbicides, safeners, micronutrients, biopesticides and/or growth regulators. In one embodiment, the agrochemical active is an insecticide. In another embodiment, the agrochemical active is a fungicide, preferably metyltetraprole. In yet another embodiment the agrochemical active is a herbicide. The skilled worker is familiar with such pesticides, which can be found, for example, in the Pesticide Manual, 16th Ed. (2013), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or their derivatives. Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic compounds, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas. Suitable plant growth regulators are antiauxins, auxins, cytokinins, defoliants, ethylene modulators, ethylene releasers, gibberellins, growth inhibitors, morphactins, growth retardants, growth stimulators, and further unclassified plant growth regulators. Suitable micronutrients are compounds comprising boron, zinc, iron, copper, manganese, chlorine, and molybdenum. Suitable nitrification inhibitors are linoleic acid, alpha-linolenic acid, methyl pcoumarate, methyl ferulate, methyl 3-(4-hydroxyphenyl) propionate (MHPP), Karanjin, brachialacton, p-benzoquinone sorgoleone, 2-chloro-6-(trichloromethyl)-pyridine (nitrapyrin or Nserve), dicyandiamide (DCD, DIDIN), 3,4-dimethyl pyrazole phosphate (DMPP, ENTEC), 4-amino-1,2,4-triazole hydrochloride (ATC), 1-amido-2-thiourea (ASU), 2-amino-4-chloro-6-methylpyrimidine (AM), 2-mercapto-benzothiazole (MBT), 5-ethoxy-3-trichloromethyl-1,2,4-thiodiazole (terrazole, etridiazole), 2-sulfanilamidothiazole (ST), ammoniumthiosulfate (ATU), 3-methylpyrazol (3-MP), 3,5-dimethylpyrazole (DMP), 1,2,4-triazol thiourea (TU), N-(1H-pyrazolylmethyl) acetamides such as N-((3(5)-methyl-1H-pyrazole-1-yl)methyl) acetamide, and N-(1H-pyrazolyl-methyl) formamides such as N-((3(5)-methyl-1H-pyrazole-1-yl)methyl formamide, N-(4-chloro-3(5)-methyl-pyrazole-1-ylmethyl)-formamide, N-(3(5),4-dimethyl-pyrazole-1-ylmethyl)formamide, neem, products based on ingredients of neem, cyan amide, melamine, zeolite powder, catechol, benzoquinone, sodium terta board, zinc sulfate, 2-(3,4-dimethyl-1H-pyrazol-1-yl)succinic acid (referred to as “DMPSA1” in the following) and/or 2-(4,5-dimethyl-1H-pyrazol-1-yl) succinic acid (referred to as “DMPSA2” in the following), and/or a derivative thereof, and/or a salt thereof; glycolic acid addition salt of 3,4-dimethyl pyrazole (3,4-dimethyl pyrazolium glycolate, referred to as “DMPG” in the following), and/or an isomer thereof, and/or a derivative thereof; citric acid addition salt of 3,4-dimethyl pyrazole (3,4-dimethyl pyrazolium citrate, referred to as “DMPC” in the following), and/or an isomer thereof, and/or a derivative thereof; lactic acid addition salt of 3,4-dimethyl pyrazole (3,4-dimethyl pyrazolium lactate, referred to as “DMPL” in the following), and/or an isomer thereof, and/or a derivative thereof; mandelic acid addition salt of 3,4-dimethyl pyrazole (3,4-dimethyl pyrazolium mandelate, referred to as “DMPM” in the following), and/or an isomer thereof, and/or a derivative thereof; 1,2,4-triazole (referred to as “TZ” in the following), and/or a derivative thereof, and/or a salt thereof; 4-Chloro-3-methylpyrazole (referred to as “CIMP” in the following), and/or an isomer thereof, and/or a derivative thereof, and/or a salt thereof; a reaction adduct of dicyandiamide, urea and formaldehyde, or a triazonyl-formaldehyde-dicyandiamide adduct; 2-cyano-1-((4-oxo-1,3,5-triazinan-1-yl)methyl) guanidine, 1-((2-cyanoguanidino)methyl) urea; 2-cyano-1-((2-cyanoguanidino)methyl)guanidine; 3,4-dimethyl pyrazole phosphate; allylthiourea, and chlorate salts. Examples of envisaged urease inhibitors include N-(n-butyl)thiophosphoric acid triamide (NBPT, Agrotain), N-(n-propyl) thiophosphoric acid triamide (NPPT), 2-nitrophenyl phosphoric triamide (2-NPT), further NXPTs known to the skilled person, phenylphosphorodiamidate (PPD/PPDA), hydroquinone, ammonium thiosulfate, and mixtures of NBPT and NPPT (see e.g. U.S. Pat. No. 8,075,659). Such mixtures of NBPT and NPPT may comprise NBPT in amounts of from 40 to 95% wt.-% and preferably of 60 to 80% wt.-% based on the total amount of active compounds. Such mixtures are marketed as LIMUS, which is a composition comprising about 16.9 wt.-% NBPT and about 5.6 wt.-% NPPT and about 77.5 wt.-% of other ingredients including solvents and adjuvants.

The agrochemical formulation may comprise the agrochemical actives in a total concentration of at least 1 wt %, preferably at least 5 wt % more preferably at least 10 wt %, most preferably at least 25 wt %, and in particular at least 40 wt % based on the total weight of the agrochemical formulation. The agrochemical formulation may comprise the agrochemical actives in a total concentration of up to 70 wt %, preferably up to 60 wt %, more preferably up to 50 wt % based on the total weight of the agrochemical formulation. The agrochemical formulation may comprise the agrochemical actives in a total concentration of from 1 to 70 wt %, preferably 1 to 60 wt %, more preferably 5 to 50 wt %, most preferably 5 to 30 wt % based on the total weight of the composition.

The agrochemical actives have a very low solubility in the continuous oil phase. Since the continuous oil phase is very lipophilic, the solubility of the agrochemical actives is best measured in a lipophilic hydrocarbon such as n-octane. The agrochemical actives typically have a solubility in n-octane at 20° C. of up to 1 g/l, preferably up to 10 mg/l, most preferably up to 100 μg/l. The agrochemical actives typically also have a very low water-solubility of up to 10 g/l, preferably up to 5 g/l at 20° C.

The agrochemical actives are present in the form of particles that are suspended in the continuous oil phase. The particles can be characterized by their size distributions, which can be determined by dynamic light scattering methods. The D50-value is a statistical figure that indicates a maximum particle diameter that characterizes 50% by volume of all particles. In other words, 50% (v/v) of all particles have a diameter that is equal or smaller than the D50 value. The D50 value for the particles in the instant case is typically up to 30 μm, preferably up to 25 μm, more preferably up to 20 μm, most preferably up to 10 μm, and especially preferably up to 7 μm. The D50 value for the particles is typically at least 0.1 μm, preferably at least 0.8 μm, more preferably at least 1 μm. The D50 value for the particles is typically from 0.5 to 10 μm, preferably from 1 to 8 μm, more preferably from 1.5 to 5 μm.

The agrochemical formulation may also comprise a water-soluble agrochemical active in the emulsified water droplets. The further agrochemical active may be selected from fungicides, insecticides, nematicides, herbicides, safeners, micronutrients, biopesticides and/or growth regulators. In one embodiment, the further agrochemical active is an insecticide. In another embodiment, the further agrochemical active is a fungicide. In yet another embodiment the further agrochemical active is a herbicide, preferably dicamba, more preferably a salt of dicamba.

The further agrochemical active is typically water-soluble. The further agrochemical active may have a water-solubility at 20° C. of at least 10 g/l, preferably at least 50 g/l, more preferably at least 100 g/l. Usually, the further agrochemical active is present in dissolved form in the emulsified water droplets.

The agrochemical formulation may comprise the further agrochemical active in a concentration of from 1 to 30 wt %, preferably 1 to 20 wt %, most preferably 1 to 15 wt % based on the total weight of the agrochemical formulation. The agrochemical formulation may comprise the further agrochemical active in a concentration of at least 2 wt %, preferably at least 5 wt % based on the total weight of the agrochemical formulation. The agrochemical formulation may comprise the further agrochemical active in a concentration of up to 25 wt %, preferably up to 10 wt % based on the total weight of the agrochemical formulation.

The agrochemical formulation contains water droplets that are emulsified in the continuous oil phase. The agrochemical formulation typically contains at least 1 wt % of water in the form of water droplets, preferably at least 3 wt % of water in the form of droplets, more preferably at least 5 wt % of water in the form of droplets, most preferably at least 10 wt % of water in the form of droplets, especially preferably at least 15 wt % of water in the form of droplets, and in particular at least 20 wt % of water in the form of droplets, e.g. at least 23 wt % of water in the form of water droplets. The agrochemical formulation typically contains up to 50 wt % of water in the form of water droplets, preferably up to 40 wt % of water in the form of droplets, more preferably up to 20 wt % of water in the form of droplets. The agrochemical formulation typically contains from 1 to 60 wt % of water in the form of water droplets, preferably from 1 to 50 wt % of water in the form of droplets, more preferably from 3 to 30 wt % of water in the form of droplets, most preferably from 5 to 25 wt %, utmost preferably from 7 to 20 wt %, especially from 10 to 15 wt %. In one embodiment, the agrochemical formulation contains from 5 to 30 wt % of water in the form of droplets. In another embodiment, the agrochemical formulation contains from 7 to 25 wt % of water in the form of droplets. In another embodiment, the agrochemical formulation contains from 8 to 20 wt % of water in the form of droplets.

The water droplets may be characterized by their size distribution similarly to the particles comprising the agrochemical active. The D50 value for the water droplets is typically up to 50 μm, preferably up to 40 μm, more preferably up to 30 μm, most preferably up to 20 μm, and especially preferably up to 10 μm, such as up to 5 μm. The D50 value for the water droplets is typically at least 0.1 μm, preferably at least 0.8 μm, more preferably at least 1 μm. The D50 value for the water droplets is typically from 0.5 to 50 μm, preferably from 1 to 30 μm, more preferably from 1.5 to 20 μm.

The agrochemical formulation comprises at least one dispersant to disperse the agrochemical actives in the continuous oil phase. Suitable dispersants are compounds that have a high affinity to the agrochemical active without dissolving it in the continuous oil phase. The dispersant is typically non-ionic and readily dissolvable in the continuous oil phase.

Examples of suitable dispersants are N-hydroxyalkyl amides of saturated and unsaturated fatty acids, preferably N, N-bisdihydroxyethyl amides of saturated and unsaturated fatty acids (e.g. Surfom OD 8104); ethoxylated sorbitans partial esters and peresters, preferably ethoxylated sorbitans oleates (e.g. Atlas G 1096, Atlas G 1086, or Arlatone TV); ethoxylated glycerol esters of hydroxy fatty acids and their derivatives, such as ethoxylated castor oil (e.g. Toximul 8243, Toximul 8245, Toximul 8248, Emulsogen EL 100), ethoxylated and hydrogenated castor oil, or ethoxylated castor oil oleate (e.g. Alkamuls VO 2003); and alkoxylated fatty alcohols and alkylaryl-sulfonates or mixtures thereof (e.g. Atlox 3467), alkoxylated fatty acid ester, preferably ethoxylated fatty acid methylester (e.g. Agnique ME 815-5), fatty alcohol alkoxylates, preferably ethoxylated C₈-C₁₈ alcohols, such as ethoxylated isodecyl and isododecyl alcohol (e.g. Foryl 5999, Lutensol ON 50, Tensiofix NTM, or Tensiofix 96 DB10), and alkoxylated polyolefins, such as polyisobutylene succinic anhydride-polyethylene glycol (e.g. Atlox 4914).

The agrochemical formulation typically contains the dispersant(s) in a total concentration of from at least 1 wt %, preferably at least 2 wt %, more preferably at least 5 wt %, most preferably at least 10 wt % based on the total weight of the agrochemical formulation. The agrochemical formulation may contain the dispersant(s) in a total concentration of up to 20 wt %, preferably up to 15 wt %, more preferably up to 12 wt % based on the total weight of the agrochemical formulation. The agrochemical formulation may contain the dispersant(s) in a total concentration of from 1 to 20 wt %, preferably 5 to 15 wt % based on the total weight of the agrochemical formulation.

The water droplets are emulsified in the continuous oil phase. To this end, the agrochemical formulation typically contains one or more water-in-oil emulsifier (W/O-emulsifier) to achieve good physical stability. Such emulsifiers are generally known to the skilled person. They may be characterized by their “hydrophilic-lipophilic balance” values (“HLB value”) as described by Michael E. Aulton, Pharmaceutics—The Science of Dosage Form Design, Second Edition, Churchill Livingston, 2001, p. 95-99. Typically, the W/O-emulsifier is a non-ionic amphoteric emulsifier, preferably containing a polyethylene oxide moiety.

Suitable W/O emulsifiers may be selected from fatty alcohol alkoxylates, preferably ethoxylated C₁₂-C₁₈ alcohols, such as isotridecyl alcohol that is ethoxylated with two ethylene oxide moieties (e.g. the Lutensol TO series of BASF); polyalkoxylates, preferably copolymers of ethylene oxide and propylene oxide (e.g. Step Flow LF or Genapol PF10); copolymers and block copolymers of glycerol with hydroxylated saturated and unsaturated fatty acids, such as polyglyceryl-2 dipolyhydroxystearate (e.g. Dehymuls PGPH), ethoxylated glycerol esters of hydroxy fatty acids and their derivatives, such as ethoxylated castor oil (e.g. Toximul 8243, Toximul 8245, Toximul 8248, Emulsogen EL 100), ethoxylated and hydrogenated castor oil, or ethoxylated castor oil oleate (e.g. Alkamuls VO2003 or Emulsogen EL0200); polyether siloxanes (e.g. Break Thru OE 440), nonionic modified polyesters (e.g. Tersperse 2520), or polyglycerol fatty acid partial esters (e.g. Tego XP11041). Preferred W/O emulsifiers are castor oil ethoxylates.

The agrochemical formulation comprises the W/O-emulsifier typically in a concentration of at least 1 wt %, preferably at least 2 wt %, more preferably at least 3 wt % based on the total weight of the agrochemical formulation. The agrochemical formulation may comprise the W/O emulsifier in a concentration of up to 20 wt %, preferably up to 15 wt %, more preferably up to 10 wt %, most preferably up to 8 wt % based on the total weight of the agrochemical formulation. The agrochemical formulation may comprise the W/O emulsifier in a concentration of from 1 to 12 wt %, preferably 1 to 10 wt %, more preferably 2 to 7 wt % based on the total weight of the agrochemical formulation.

The weight ratio of the W/O-emulsifier to the water that is in the form of emulsified water droplets is typically from 1:10 to 1:1, preferably from 1:10 to 1:2, more preferably from 1:6 to 1:2.

Since most applicants dilute the agrochemical formulation in an aqueous tank-mix composition, it is advantageous to add an oil-in-water emulsifier (O/W-emulsifier) to the agrochemical formulation to disperse the oil-based formulation in water. Such emulsifiers are also generally known to the skilled person.

Examples of suitable O/W-emulsifiers are ethoxylated sorbitans partial esters and peresters, preferably ethoxylated sorbitans oleates (e.g. Tween 85, e.g. Atlas G 1096, Atlas G 1086, or Arlatone TV), alkoxylated fatty alcohols and alkyl-aryl-sulfonates or mixtures thereof (e.g. Atlox 3467), ethoxylated glycerol esters of hydroxy fatty acids and their derivatives, such as ethoxylated castor oil (e.g. Toximul 8243, Toximul 8245, Toximul 8248, Emulsogen EL 100), ethoxylated and hydrogenated castor oil, or ethoxylated castor oil oleate (e.g. Alkamuls VO 2003), N-hydroxyalkyl amides of saturated and unsaturated fatty acids, preferably N, N-bisdihydroxyethyl amides of saturated and unsaturated fatty acids (e.g. Surfom OD 8104).

The agrochemical formulation comprises the O/W-emulsifier typically in a concentration of at least 1 wt %, preferably at least 2 wt %, more preferably at least 3 wt % based on the total weight of the agrochemical formulation. The agrochemical formulation may comprise the O/W-emulsifier in a concentration of up to 20 wt %, preferably up to 15 wt %, more preferably up to 10 wt %, most preferably up to 8 wt % based on the total weight of the agrochemical formulation. The agrochemical formulation may comprise the O/W-emulsifier in a concentration of from 1 to 20 wt %, preferably 5 to 15 wt %, more preferably 2 to 7 wt % based on the total weight of the agrochemical formulation.

The weight ratio of the O/W-emulsifier to the water-immiscible solvent in the agrochemical formulation is typically from 1:1 to 1:20, preferably from 1:5 to 1:15, more preferably from 1:7 to 1:12.

The O/W-emulsifiers, W/O-emulsifiers and dispersants as described above are all part of the generic class of surfactants. and do not form clearly distinguishable functional groups within this class. Instead, the skilled person knows that these groups of surfactants may overlap and that certain compounds may be suitable to be included for more than one function, e.g. some dispersants may also act as an O/W-emulsifier.

The total concentration of surfactant, i.e. the sum of dispersants, O/W-emulsifiers, and W/O-emulsifiers, is typically at least 5 wt %, preferably at least 10 wt %, more preferably at least 15 wt %, most preferably at least 20 wt % based on the total weigh of the agrochemical composition. The total concentration of surfactant may be up to 40 wt %, preferably up to 30 wt %, more preferably up to 25 wt % based on the total weight of the agrochemical formulation. The total concentration of surfactant may be from 10 to 35 wt %, preferably from 15 to 30 wt % based on the total weight of the agrochemical formulation.

The following formulations are preferred embodiments of the agrochemical formulations of the present invention:

I. Agrochemical formulation comprising
a) a continuous oil phase comprising a water-immiscible solvent;
b) four agrochemical actives, Saflufenacil, Trifludimoxazin, Pyroxasulfone and Imazethapyr, in the form of particles, which particles are suspended in the continuous oil phase;
c) a dispersant, which is an alkoxylated fatty acid ester;
d) water droplets that are emulsified in the continuous oil phase; and
e) a water-in-oil-emulsifier;
wherein the agrochemical formulation is substantially free of a thickener.

II. Agrochemical formulation comprising
a) a continuous oil phase comprising a water-immiscible solvent;
b) four agrochemical actives, Saflufenacil, Trifludimoxazin, Pyroxasulfone and Imazethapyr, in the form of particles, which particles are suspended in the continuous oil phase;
c) a dispersant, which is an alkoxylated fatty acid ester;
d) water droplets that are emulsified in the continuous oil phase;
e) a water-in-oil-emulsifier; and
f) an oil-in water-emulsifier;
wherein the agrochemical formulation is substantially free of a thickener.

III. Agrochemical formulation comprising
a) 20 to 80 wt % of a continuous oil phase comprising a water-immiscible solvent;
b) 1 to 70 wt % total of the four agrochemical actives, Saflufenacil, Trifludimoxazin, Pyroxasulfone and Imazethapyr, in the form of particles, which particles are suspended in the continuous oil phase;
c) at least 1 wt % of a dispersant, which is an alkoxylated fatty acid ester, preferably an ethoxylated fatty acid methylester;
d) 1 to 50 wt % of water droplets that are emulsified in the continuous oil phase; and
e) at least 1 wt % of a water-in-oil emulsifier;
wherein the agrochemical formulation is substantially free of a thickener.

IV. Agrochemical formulation comprising
a) 20 to 80 wt % of a continuous oil phase comprising a water-immiscible solvent;
b) 1 to 60 wt % total of the four agrochemical actives, Saflufenacil, Trifludimoxazin, Pyroxasulfone and Imazethapyr, in the form of particles, which particles are suspended in the continuous oil phase;
c) at least 1 wt % of a dispersant, which is an alkoxylated fatty acid ester, preferably an ethoxylated fatty acid methylester;
d) 3 to 30 wt % of water droplets that are emulsified in the continuous oil phase; and
e) at least 1 wt % of a water-in-oil emulsifier;
wherein the agrochemical formulation is substantially free of a thickener.

V. Agrochemical formulation comprising
a) 20 to 80 wt % of a continuous oil phase comprising a water-immiscible solvent;
b) 1 to 60 wt % total of the four agrochemical actives, Saflufenacil, Trifludimoxazin, Pyroxasulfone and Imazethapyr, in the form of particles, which particles are suspended in the continuous oil phase;
c) at least 1 wt % of a dispersant, which is an alkoxylated fatty acid ester, preferably an ethoxylated fatty acid methylester;
d) 3 to 30 wt % of water droplets that are emulsified in the continuous oil phase;
e) at least 1 wt % of a water-in-oil emulsifier; and
f) at least 1 wt % of an oil-in-water emulsifier wherein the agrochemical formulation is substantially free of a thickener.

VI. Agrochemical formulation comprising
a) 30 to 60 wt % of a continuous oil phase comprising a water-immiscible solvent, preferably methylated soybean oil;
b) 5 to 30 wt % total of the four agrochemical actives, Saflufenacil, Trifludimoxazin, Pyroxasulfone and Imazethapyr, in the form of particles, which particles are suspended in the continuous oil phase;
c) 5-15 wt % total of the dispersants alkoxylated fatty acid ester, preferably ethoxylated fatty acid methylester, ethoxylated sorbitans oleate and a mixture of alkoxylated fatty alcohols and alkyl-aryl-sulfonates;
d) 7 to 25 wt % of water droplets that are emulsified in the continuous oil phase; and
e) at least 1 wt % of a water-in-oil emulsifier, preferably a castor oil ethoxylate;
wherein the agrochemical formulation is substantially free of a thickener.

The agrochemical formulation is prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005. Typically, the water-immiscible solvent and the agrochemical actives are contacted in a first step a) to form a premix. The contacting may be achieved by mixing, shaking, or just by adding the agrochemical actives to the water-immiscible solvent.

In subsequent step b), the premix is milled to form a raw suspension of the agrochemical active. The milling may be done in typical milling devices, such as ball mills, bead mills, rod mills, semi- and autogenous mills, pebble mills, grinding roll mills, Buhrstone mills, tower mills, hammer mills, planetary mills, vertical-shaft-impactor mills, colloid mills, cone mills, disk mills, edge mills, jet mills, pellet mills, stirred mills, three roll mills, vibratory mills, Wiley mills or similar milling and grinding devices known by the skilled person.

In step c), water is then emulsified in the raw suspension of step b). Step c) typically comprises the sub-steps c1) of addition of water to the raw suspension, followed by c2) the formation of water droplets in the continuous oil phase by emulsification. Emulsification may be achieved by intense mixing, shaking, or milling in dispersing devices. To facilitate the emulsification of the water in the continuous oil phase, a W/O-emulsifier may be added in any step of the method for preparing the agrochemical formulation. Preferably, the W/O-emulsifier is added before step c2). The W/O-emulsifier may be added in step a), step b), or step c). If the W/O-emulsifier is added in step c), it may be added with the water.

A dispersant and/or an O/W-emulsifier may be added in any of steps a), b), or c). Typically, the dispersant is added before or during the milling in step b). Preferably, the dispersant is added in step a) to form a premix. The O/W-emulsifier may preferably be added in step a) or step b).

The invention also relates to a method for stabilizing an oil dispersion comprising the step of a) providing a continuous oil phase containing solid particles dispersed therein; and b) emulsifying water droplets in the continuous oil phase; wherein the oil dispersion is substantially free of a thickener

The term “increasing the stability” usually refers to the physical stability of the dispersion, e.g. an improvement of the settling behavior of the dispersed particles.

The invention also relates to a method for increasing the viscosity (preferably the dynamic viscosity) of a continuous oil phase (preferably of an oil dispersion) comprising the steps of a) providing a continuous oil phase; and b) emulsifying water droplets in the continuous oil phase, wherein the continuous oil phase is substantially free of a thickener.

Suitable means and methods for emulsifying the water-droplets in the continuous oil phase are as outlined above. Typically, the method comprises adding a W/O-emulsifier.

The method for stabilizing an oil dispersion and the method for increasing the viscosity of a continuous oil phase do neither contain the addition of a thickener to the oil dispersion or the continuous oil phase, nor does the oil dispersion nor the continuous oil phase contain a thickener from the start.

The invention also relates to the use of emulsified water droplets to increase the viscosity (preferably the dynamic viscosity) of an oil dispersion, in particular if the oil dispersion is substantially free of a thickener.

The agrochemical formulation may comprise further auxiliaries. Suitable auxiliaries solid carriers or fillers, surfactants, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, UV filters, tackifiers and binders.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, non-ionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in Mccutcheon's, Vol. 1: Emulsifiers & Detergents, Mccutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignin sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkyl-naphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable non-ionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compound I on the target. Examples are surfactants, mineral or vegetable oils, and other auxilaries. Further examples are listed by Knowles, Adjuvants and additives, Agrow Reports DS256, T&F Informa UK, 2006, chapter 5.

Typically, the agrochemical formulation is substantially free of a thickener. The term “substantially free” as used herein typically relates to an agrochemical formulation comprising a thickeners to a concentration of not more than 1 wt %, more preferably not more than 0.1 wt %, most preferably not more than 0.01 wt %, each time based on the total weight of the agrochemical composition. In one embodiment, the agrochemical formulation does not contain a thickener.

The term “thickener(s)” usually refers to inorganic clays (organically modified or unmodified), such as bentonintes, hectorite and smectite clays, and silicates (e.g. colloidal hydrous magnesium silicate, colloidal hydrous aluminium silicate, colloidal hydrous aluminium magnesium silicate, hydrous amorphous silicon dioxide); and organic clays, such as polycarboxylates (e.g. poly(meth)acrylates and modified poly(meth)acrylates), polysaccharides (e.g. xanthan gum, agarose, rhamsan gum, pullulan, tragacanth gum, locust bean gum, guar gum, tara gum, Whelan cum, casein, dextrin, diutan gum, cellulose, ethylcellulose, hydroxyethylcellulose, methylhydroxypropylcellulose), polyvinyl ethers, polyvinyl pyrrolidone, polypropylene oxidepolyethylene ocide condensates, polyvinyl acetates, maleic anhydrides, polypropylene glycols, polyacrylonitrile block copolymers, proteins, and carbohydrates.

The skilled person is aware that thickening effects of thickeners depend on the physicochemical nature of a given liquid composition as compared to the molecular structure of a thickener. If the thickener predominantly contains polar functional groups, such as OH, COOH or SO₃H, the skilled person understands that such a thickener is predominantly applicable in polar, preferably protic solvents. Most prominently, xanthan gum and other non-modified polysaccharides are only able to unfold their full thickening of a liquid composition, if water or other protic solvents are added to the composition. On the other hand, if the thickener contains substantial hydrophobic moieties, it may be suitable for increasing the viscosity of non-polar solvents, such as in the case of dibutyl-lauroyl-glutamide. The skilled person is capable to identify thickeners that increase the viscosity of any given liquid composition by comparing the molecular structure of the thickener with the physico-chemical properties of the liquid composition.

On a functional level, the term “thickener” as used herein refers to a compound that increases the dynamic viscosity of a liquid composition if added, as compared to the same liquid composition without the compound.

A thickener may be defined as a compound that increases the dynamic viscosity of water of at least 0.1 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 0.5 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 1 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 5 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 10 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 25 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 50 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 100 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 250 mPas at 25° C. and at a shear rate of 100/second, if the thickener is added at to the water at a concentration of 1 wt %, wherein the water has a standard water hardness according to CIPAC of 342 ppm and a pH of 6.0-7.0.

A thickener may also be defined as a compound that increases the dynamic viscosity of soybean oil methyl ester of at least 0.1 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 0.5 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 1 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 5 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 10 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 25 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 50 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 100 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 250 mPas at 25° C. and at a shear rate of 100/second, if the thickener is added at to the soybean oil methyl ester at a concentration of 1 wt %.

A thickener may be defined as a compound that increases the dynamic viscosity of water or soybean oil methyl ester of at least 0.1 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0. In one embodiment, the thickener increases the dynamic viscosity of water or soybean oil methyl ester of at least 0.5 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 1 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 5 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 10 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 25 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 50 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 100 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 250 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

For the avoidance of doubt, the term “thickener” does not relate to the water droplets that are emulsified in the continuous oil phase.

The dynamic viscosity according to the invention is usually measured by means of a Brookfield viscosimeter, i.e. a rotational viscosimeter with a cone-plate geometry. The dynamic viscosity may be determined according to industry standard EN ISO 2555:2018. Usually, the dynamic viscosity is measured at 25° C. In this method, the shear rate of the rotation viscosimeter is constantly increased and the shear stress is measured. For Newtonian Fluids, the measurement results in a linear dataset according to a direct proportionality between the shear stress and the shear rate. For non-Newtonian fluids, the measurement results in a non-linear dependency between shear stress and shear rate. The dynamic viscosity, also called apparent viscosity, is typically determined by measuring the slope of a line through the origin of the coordinate system and the shear stress as determined at a shear rate of 100/second. The true viscosity, which may be different from the apparent viscosity for non-Newtonian fluids, is determined by calculating the slope of the tangent of the experimental curve as measured at a shear rate of 100/second.

The agrochemical formulation usually has a true viscosity of from 60 mPas to 1000 mPas, preferably from 60 mPas to 900 mPas, more preferably from 80 to 800 mPas. The agrochemical formulation usually has an apparent viscosity of from 80 mPas to 2000 mPas, preferably from 100 mPas to 1500 mPas, more preferably from 150 mPas to 1000 mPas, most preferably from 200 mPas to 800 mPas.

Suitable bactericides are bronopol and isothiazolinone derivatives such as alkylisothiazolinones and benzisothiazolinones.

Suitable anti-freezing agents are ethylene glycol, propylene glycol, urea and glycerin. Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

The term “UV filters” is understood as meaning inorganic or organic compounds which are able to absorb ultraviolet rays and give off the absorbed energy again in the form of longer-wave radiation, e.g. heat. The term “UV filter” relates to one type or a mixture of different types of said compounds. Suitable examples of UV filters are a) benzotriazoles, such as 2-(2H-benzotriazol-2-yl)-4,6-bis(1-methyl-1-phenylethyl) phenol (Tinuvin® 900, CIBA AG), [3-[3-(2H-benzotriazol-2-yl)-5-(1,1-dimethylethyl)-4-hydroxyphenyl]-1-oxopropyl]-w-[3-[3-(2H-benzotriazol-2-yl)-5-(1,1-dimethylethyl)-4-hydroxyphenyl]-1-oxopropoxy]poly(oxy-1,2-ethanediyl) (Tinuvin® 1130, CIBA AG), 6-tert.-butyl-2-(5-chloro-2H-benzotriazol-2-yl)-4-methylphenol, 2,4-di-tert-butyl-6-(5-chloro-2H-benzotriazol-2-yl)-phenol, 2-(2H-benzotriazol-2-yl)-4,6-di-tert.-pentylphenol, 2-(2H-benzotriazol-2-yl)-4-(1,1,3,3-tetramethylbutyl)-phenol, 2-(2H-benzotriazol-2-yl)-4-methylphenol, 2-(2H-benzotriazol-2-yl)-4,6-bis(1-methyl-1-phenylethyl) phenol; b) cyanoacrylate derivatives, such as ethyl 2-cyano-3-phenylcinnamate (Uvinul® 3035, BASF SE), 2-cyano-3,3-diphenylacrylic acid-2′-ethylhexyl ester or 2-ethylhexyl 2-cyano-3-phenylcinnamate (octocrylene, Uvinul® 539 T, Uvinul 3039, BASF SE); c) para-aminobenzoic acid (PABA) derivatives, especially esters, such as ethyl-PABA, ethoxylated PABA, ethyl-dihydroxypropyl-PABA, GlycerolPABA, 2-ethylhexyl 4-(dimethylamino)benzoate (Uvinul® MC 80), 2-octyl-4-(dimethylamino) benzoate, amyl 4-(dimethylamino) benzoate, 4-bis(polyethoxy)-4-amino benzoic acid polyethoxyethyl ester (Uvinul® P 25, BASF SE); d) esters of salicylic acid, such as 2-ethylhexyl salicylate, 4-isopropylbenzyl salicylate, homomenthyl salicylate, TEA salicylate (Neo Heliopan® TS, Haarmann and Reimer), dipropyleneglycol salicylate; e) esters of cinnamic acid, such as 2-ethylhexyl 4-methoxycinnamate (Uvinul® MC 80), octyl-p-methoxycinnamate, propyl 4-methoxycinnamate, isoamyl-4-methoxycinnamate, conoxate, diisopropyl methylcinnamate, etocrylene (Uvinul® N 35, BASF SE); f) derivatives of benzophenone, such as 2-hydroxy-4-methoxybenzophenone (Uvinul® M 40, BASF SE), 2-hydroxy-4-methoxy-4′-methylbenzophenone, 2,2′-dihydroxy-4-methoxybenzophenone, 2-(4-diethylamino-2-hydroxybenzoyl)-benzoic acid hexylester (Uvinul® A Plus, BASF SE), 4-n-octyloxy-2-hydroxybenzophenone (Uvinul® 3008, BASF SE), 2-hydroxybenophenone derivatives such as 4-hydroxy-, 4-methoxy-, 4-octyloxy-, 4-decyloxy-, 4-dodecyloxy-, 4-benzyloxy-, 4,2′,4′-trihydroxy-; 2′-hydroxy-4,4′-dimethoxy-2-hydroxybenzophenone; g) sulfonic acid derivatives of benzophenones, such as 2-hydroxy-4-methoxybenzo-phenone-5-sulfonic acid (Uvinul® MS 40, BASF SE) and its salts, 2,2′-dihydroxy-4,4′-dimethoxybenzophenone-5,5′-sulfonic acid and its salts (disodium salt: Uvinul® DS 49, BASF SE); h) 3-benzylidenecamphor and derivatives thereof, such as 3-(4′-methylbenzylidene) d-1-camphor, benzylidiene camphor sulfonic acid (Mexoryl® SO, Chimex); j) sulfonic acid derivatives of 3-benzylidenecamphor, such as 4-(2-oxo-3-bornylidenemethyl)benzenesulfonic acid and 2-methyl-5-(2-oxo-3-bornylidene) sulfonic acid and salts thereof; k) esters of benzalmalonic acid, such as 2-ethylhexyl 4-methoxybenzmalonate; m) triazine derivatives, such as dioctylbutamidotriazone (Uvasorb® HEB, Sigma), 2,4,6-trinanilino-p-(carbo-2′-ethyl-hexyl-1′-oxy)-1,3,5-triazine (Uvinul® T 150, BASF SE), 2-[4-[(2-Hydroxy-3-(2′-ethyl) hexyl)oxy]-2-hydroxyphenyl]-4,6bis(2,4-dimethylphenyl)-1,3,5-triazine (Tinuvin® 405, CIBA AG), anisotriazine (Tinosorb® S, CIBA AG), 2,4,6-tris(diisobutyl-4′-aminobenzalmalonate)-striazine; n) propane-1,3-diones, such as, 1-(4-tert-butylphenyl)-3-(4′-methoxyphenyl) propane-1,3-dione; o) 2-phenylbenzimidazole-5-sulfonic acid or 2-phenylbenzimidazole-4-sulfonic acid and alkali metal, alkaline earth metal, ammonium, alkylammonium, alkanolammonium and glucammonium salts thereof; p) derivatives of benzoylmethane, such as, 1-(4′-tert-butylphenyl)-3-(4′-methoxyphenyl) propane-1,3-dione, 4-tert-butyl-4′-methoxydibenzoylmethane or 1-phenyl-3-(4′-isopropylphenyl) propane-1,3-dione; q) aminohydroxy-substituited derivatives of benzophenones, such as N,N-diethylaminohydroxybenzoyl-n-hexylbenzoate; r) inorganic absorbers e.g. based on ZnO (e.g. Z-Cote® products, BASF SE), TiO₂ (e.g. T-Lite™ products, BASF SE) or CeO₂; and s) mixtures of UV filters of groups a) to r), such as a mixture of pmethoxycinnamic acid ethylhexyl ester (65%) and 2-(4-diethylamino-2-hydroxybenzoyl)benzoic acid hexylester (35%) (Uvinul® A Plus B, BASF SE);

Suitable tackifiers or binders are polyvinylpyrrolidons, polyvinylacetates, polyvinyl alcohols, polyacrylates, biological or synthetic waxes, and cellulose ethers.

The invention also relates to a method for controlling undesired plant growth, where the agrochemical formulation is allowed to act on the undesired plants and/or the useful plants and/or their habitat.

The method typically comprises the treatment of the plant to be protected or its locus of growth, with the agrochemical formulation.

Suitable methods of treatment include inter alia soil treatment, seed treatment, in furrow application, and foliar application. Soil treatment methods include drenching the soil, drip irrigation (drip application onto the soil), dipping roots, tubers or bulbs, or soil injection. Seed treatment techniques include seed dressing, seed coating, seed dusting, seed soaking, and seed pelleting. In furrow applications typically include the steps of making a furrow in cultivated land, seeding the furrow with seeds, applying the pesticidally active compound to the furrow, and closing the furrow.

In one embodiment of the method of application, the plant is an agricultural plant and/or the propagation material relates to propagation material of such agricultural plants, wherein the agricultural plant is selected from wheat, barley, oat, rye, soybean, corn, potatoes, oilseed rape, canola, sunflower, cotton, sugar cane, sugar beet, rice or a vegetable such as spinach, lettuce, asparagus, or cabbages; or sorghum; a silvicultural plant; an ornamental plant; and a horticultural plant, each in its natural or in a genetically modified form.

In one embodiment, the plant to be treated according to the method of the invention is an agricultural plant. “Agricultural plants” are plants of which a part (e.g. seeds) or all is harvested or cultivated on a commercial scale or which serve as an important source of feed, food, fibers (e.g. cotton, linen), combustibles (e.g. wood, bioethanol, biodiesel, biomass) or other chemical compounds. Preferred agricultural plants are for example cereals, e.g. wheat, rye, barley, triticale, oats, corn, sorghum or rice, beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, oil-seed rape, canola, linseed, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola, sugar cane or oil palm; tobacco; nuts; coffee; tea; bananas; vines (table grapes and grape juice grape vines); hop; turf; natural rubber plants.

In a preferred embodiment, the plant to be treated according to the method of the invention is soybean.

In a further embodiment, the plant to be treated according to the method of the invention is a horticultural plant. The term “horticultural plants” are to be understood as plants which are commonly used in horticulture, e.g. the cultivation of ornamentals, vegetables and/or fruits. Examples for ornamentals are turf, geranium, pelargonia, petunia, begonia and fuchsia. Examples for vegetables are potatoes, tomatoes, peppers, cucurbits, cucumbers, melons, watermelons, garlic, onions, carrots, cabbage, beans, peas and lettuce and more preferably from tomatoes, onions, peas and lettuce. Examples for fruits are apples, pears, cherries, strawberry, citrus, peaches, apricots and blueberries.

In a further embodiment, the plant to be treated according to the method of the invention is an ornamental plant. “Ornamental plants” are plants which are commonly used in gardening, e.g. in parks, gardens and on balconies. Examples are turf, geranium, pelargonia, petunia, begonia and fuchsia.

In another embodiment of the present invention, the plant to be treated according to the method of the invention is a silvicultural plant. The term “silvicultural plant” is to be understood as trees, more specifically trees used in reforestation or industrial plantations. Industrial plantations generally serve for the commercial production of forest products, such as wood, pulp, paper, rubber tree, Christmas trees, or young trees for gardening purposes. Examples for silvicultural plants are conifers, like pines, in particular Pinus spec., fir and spruce, eucalyptus, tropical trees like teak, rubber tree, oil palm, willow (Salix), in particular Salix spec., poplar (cottonwood), in particular Populus spec., beech, in particular Fagus spec., birch, oil palm, and oak.

In one embodiment of the method of application, the inventive formulations are suitable for controlling a large number of harmful plants in agricultural crops, including monocotyledonous weeds, in particular annual weeds such as gramineous weeds (grasses) including Echinochloa species such as barnyardgrass (Echinochloa crusgalli var. crus-galli), Echinchloa walteri (Pursh) Heller, jungle rice (Echinochloa colona), Echinochloa crus-pavonis, Echinochloa oryzicola, Digitaria species such as crabgrass (Digitaria sanguinalis), Digitaria horizontalis, sourgrass (Digitaria insularis) or naked crabgrass (Digitaria nuda), Setaria species such as green foxtail (Setaria viridis), giant foxtail (Setaria faberii), yellow foxtail (Setaria glauca or Setaria pumila) or Setaria verticillata, Sorghum species such as johnsongrass (Sorghum halepense Pers.), Avena species such as wild oats (Avena fatua), Avena sterillis or Avena strigosa, Cenchrus species such as field sandbur (Cenchrus pauciflorus) or Cenchrus echinatus, Bromus species such as Bromus japonicus Thunb, Bromus sterilis or Bromus tectorum, Lolium species, Phalaris species such as Phalaris brachystachys, Phalaris minor or Phalaris persicaria, Eriochloa species, Panicum species such as fall Panicum (Panicum dichotomiflorum), Panicum fasciculatum or Panicum maximum, Brachiaria species, annual bluegrass (Poa annua), Alopecurus species such as blackgrass (Alopecurus myosuroides), Alopecurus aequalis Sobol or Alopecurus japonicus Steud, Aegilops species such as Aegilops cylindrica or Aegylops tauschii, Apera spica-venti, Eleusine indica, Cynodon dactylon, couch grass (Agropyron repens or Elymus repens), Agrostis alba, Beckmannia syzigachne (Steud.) Fernald, Chloris species such as Chloris virgata, Commelina species such as Commelina benghalensis, Commelina communis, Commelina diffusa or Commelina erecta, Dactyloctenium aegyptium, Hordeum jubatum, Hordeum leporinum, Imperata cylindrica, Ischaemum rogusum, Ixophorus unisetus, Leerisa hexandra, Leersia japonica, Leptochloa species such as Leptochloa chinensis, Leptochloa fascicularis, Leptochloa filiformis or Leptochloa panicoides, Lolium species such as Lolium multiflorum, Lolium perenne, Lolium persicum or rigid ryegrass (Lolium rigidum), Luziola subintegra, Murdannia nudiflora (L.) Brenan, Oryza latifolia, Oryza rufipogon, Paspalum distichum, Paspalum species, Pennisetum americanum, Pennisetum purpureum, Phleum paniculatum, Phragmites australia, Ploypogon fugax. N., Poa species such as Poa annua or Poa trivialis L., Puccinellia distans, Rottboellia cochinchinensis, Sclerochloa kengiana (Ohwi) Tzvel., Trichloris crinita, Urochloa or Brachiaria species such as Brachiaria decumbens, Brachiaria plantaginea, Brachiaria platyphylla, Urochloa panicoides, Urochloa ramosa and the like.

In another embodiment of the method of application, the inventive formulations are suitable for controlling a large number of dicotyledonous weeds, in particular broad leaf weeds including Polygonum species such as wild buckwheat (Polygonum convolvolus), Polygonum pensilvanicum, Polygonum persicaria or prostrate knotweed (Polygonum aviculare), Amaranthus species such as pigweed (Amaranthus retroflexus), Palmer amaranth (Amaranthus palmeri), tall waterhemp (Amaranthus tuberculatus or Amaranthus rudis), redroot pigweed (Amaranthus retroflexus), green amaranth (Amaranthus hybridus), purple amaranth (Amaranthus lividus), prickly amaranth (Amaranthus spinosus) or Amaranthus quitensis, Chenopodium species such as common lambsquarters (Chenopodium album L.), Chenopodium serotinum or Quinoa (Chenopodium quinoa), Sida species such as prickly Sida (Sida spinosa L.), Ambrosia species such as common ragweed (Ambrosia artemisiifolia) or giant ragweed (Ambrosia trifida), Acanthospermum species, Anthemis species such as Anthemis arvensis or Anthemis cotula, Atriplex species, Cirsium species such as Cirsium arvense, Convolvulus species such as field bindweed (Convolvulus arvensis), Conyza species such as horseweed (Conyza canadensis, Erigeron canadensis) or hairy fleabane (Conyza bonariensis, Erigeron bonariensis), Cassia species, Datura species such as jimsonweed (Datura stramonium), Euphorbia species such as toothed spurge (Euphorbia dentata), Euphorbia hirta, Euphorbia helioscopia or fireplant (Euphorbia heterophylla), Geranium species such as Geranium donianum or Geranium pusillum, Galinsoga species, morningglory (Ipomoea species), Lamium species such as henbit dead-nettle (Lamium amplexicaule), Malva species such as dwarf mallow (Malva neglecta) or cheeseweed (Malwa parviflora), Matricaria species such as chamomile (Matricaria chamomilla) or Matricaria inodora, Sysimbrium species, Solanum species such as black nightshade (Solanum nigrum), Xanthium species, Veronica species such as Veronica polita, Viola species, common chickweed (Stellaria media), velvetleaf (Abutilon theophrasti), Sesbania species such as Sesbania exaltata, Sesbania herbacea or hemp Sesbania (Sesbania exaltata Cory), Anoda cristata, Bidens species such as Bidens frondosa or Bidens pilosa, Brassica kaber, Capsella species such as Capsella media or Capsella bursa-pastoris, Centaurea cyanus, Galeopsis tetrahit, Galium aparine, Helianthus annuus, Desmodium tortuosum, Kochia scoparia, Mercurialis annua, Myosotis arvensis, Papaver rhoeas, Raphanus species such as wild radish (Raphanus raphanistrum), Salsola species such as Salsola tragus or Salsola kali, Sinapis arvensis, Sonchus species such as Sonchus asper, Sonchus arvensis or Sonchus oleraceus, Thlaspi arvense, Tagetes minuta, Richardia species such as Richardia scabra or Richardia brasiliensis, Aeschynomeme species such as Aeschynomene denticulata, Aeschynomene indica orAeschynomene rudis, Alisma species such as Alisma canaliculatum or Alisma plantago-aquatica, Borreria species such as Borreria verticillata, Brassica rapa, Carduus acanthoides, Parietaria debilis, Portulaca oleracea, Ipomoea species such as Ipomoea grandifolia, Ipomoea hederacea, Ipomoea indivisa, Ipomoea lacunose, Ipomoea lonchophylla or Ipomoea wrightii, Senna obtusifolia, Sida species such as arrowleaf Sida (Sida rhombifolia) or prickly Sida (Sida spinosa), Spermacoce latifolia, Tridax procumbens, Trianthema portulacastrum, Parthenium hysterophorus, Portulaca oleracea, Acalypha australis, Ammi majus, Atriplex species, Orobanche species, Mercurialis annua, Cirsium arvense, Calystegia sepium, Stellaria media, Lamium species, Viola species, Celosia argentea, Melampodium divaricatum, Cleome viscosa, Molugo verticilatus, Borhevia erecta, Gomphrena species, Nicandra physalodes, Ricinus communis, Geranium dissectum, Alternanthera species such as Althernanthera philoxeroides or Alternanthera tenella, Ammannia species such as Ammania coccinea, Anacamtodon fortunei Mitt., Anagallis arvensis, Aneilema keisak, Arenaria serpyllifolia, Argemone mexicana, Asphodelus tenuifolius, Atriplex patula, Bacopa rotundifolia, Brassica napus, Caperonia species such as Caperonia castaneifolia or Caperonia palustris, Cephalanoplos segetum, Corynopus didymus, Crepis capillaris, Crepis tectorum, Croton lobatus, Descuminia sophia (L.), Descurainia pinnata, Echinodorus grandiflorus, Eclipta alba, Eclipta prostrata, Eichhornia crassipes, Eleocharis species, Equisetum arvense, Fallopia convolvulus, Fallopia convolvulus, Heteranthera limosa, Jussiaea species, Kallstroemia maxima, Lactuca serriola, Lathyrus aphaca, Launea mudicaulis, Leucas chinensis, Limnocharis flava, Lindernia dubia, Lindernia pyxidaria, Litospermum arvense, Ludwigia species such as Ludwigia octovallis, Macroptilium lathyroides, Malachium aquaticum (L.), Melilotus species, Merremia aegyptia, Momordica charantia, Monochoria hastate, Monochoria vaginalis, Mucuna species, Murdannia nudiflora, Oxalis neaei, Phylanthus species, Physalis species, Pistia stratiotes, Potamogeton distinctus, Rorippa islandica, Rotala indica, Rotala ramosior, Rumex dentatus, Rumex obtusifolius, Sagittaria montevidensis, Sagittaria pygmaea Miq., Sagittaria sagittifolia, Sagittaria trifolia L., Senecio vulgaris, Sicyos polyacanthus, Silene gallica, Sisymbrium species such as Sisymbrium oficinale, Solanum species, Spergula arvensis, Sphenoclea zeylanica, Trianthema spp., Tripleurospermum inodorum, Veronica species such as Veronica persica or Veronica polita Vicia sativa and the like.

In a further embodiment of the method of application, the inventive formulations are suitable for controlling a large number of annual and perennial sedge weeds including Cyperus species such as purple nutsedge (Cyperus rotundus L.), yellow nutsedge (Cyperus esculentus L.), himekugu (Cyperus brevifolius H.), sedge weed (Cyperus microiria Steud), rice flatsedge (Cyperus iria L.), Cyperus difformis, Cyperus difformis L., Cyperus esculentus, Cyperus ferax, Cyperus flavus, Cyperus iria, Cyperus lanceolatus, Cyperus odoratus, Cyperus rotundus, Cyperus serotinus Rottb., Eleocharis acicularis, Eleocharis kuroguwai, Fimbristylis dichotoma, Fimbristylis miliacea, Scirpus grossus, Scirpus juncoides, Scirpus juncoides Roxb, Scirpus or Bolboschoenus maritimus, Scirpus or Schoenoplectus mucronatus, Scirpus planiculmis Fr. Schmidt and the like.

When employed in plant protection, the amounts of agrochemical active applied are, depending on the kind of effect desired, from 0.001 to 2 kg per ha, preferably from 0.005 to 2 kg per ha, more preferably from 0.05 to 0.9 kg per ha, and in particular from 0.1 to 0.75 kg per ha.

When used in the protection of materials or stored products, the amount of active compound applied depends on the kind of application area and on the desired effect. Amounts customarily applied in the protection of materials are 0.001 g to 2 kg, preferably 0.005 g to 1 kg, of active compound per cubic meter of treated material.

Various types of oils, wetters, adjuvants, fertilizer, or micronutrients, and further pesticides (e.g. herbicides, insecticides, fungicides, growth regulators, safeners) may be added to the active compounds or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

Advantages of the present invention are that no thickening agent is required, that no biocide is required, and that agrochemical actives that degrade over time in the presence of water can be stabilized as compared to formulations having a continuous aqueous phase.

The following examples illustrate the invention.

### Ingredients:

Pesticide A: Saflufenacil
Pesticide B: Trifludimoxazin
Pesticide C: Pyroxasulfone
Pesticide D: Imazethapyr (acid form)
Dispersant A (O/W Emulsifier A): Mixture of alkoxylated fatty alcohols and alkyl-aryl-sulfonates
Dispersant B (O/W Emulsifier B): Polyoxyethylene (50) sorbitol hexaoleate
Dispersant C (O/W Emulsifier C): Ethoxylated Fatty Acid Methylester
Dispersant D (O/W Emulsifier D): Polyoxyethylen (40) sorbitol hexaoleate
W/O Emulsifier A: Castor Oil Ethoxylate (5 EO)
W/O Emulsifier B: Castor Oil Ethoxylate (10 EO)
W/O Emulsifier C: Castor Oil Ethoxylate (12 EO)
W/O Emulsifier D: Castor Oil Ethoxylate (20 EO)
Solvent A: soybean oil methyl ester

### EXAMPLE-1

The agrochemical formulations AA to AH containing Pesticides A to D were prepared with the ingredients as indicated in Tables 1 and 2 as follows. The solvent was mixed with the pesticides, the dispersant, and the O/W-emulsifier to a premix. Mixing was performed with an Ultra-Turrax IKA T18 device for 1.5 minutes at 16,000 rpm. A volume of 250 ml of the premix was then milled with a Getzmann basket mill at 3000 rpm for 20 minutes at a maximum temperature of 35° C. under addition of 28 ml of zirconium oxide beads with a diameter of 1.0 to 1.2 mm to a raw suspension. Subsequently, the W/O-emulsifier was added to the raw suspension and the resulting composition was again mixed with the Ultra-Turrax device at 5,000 rpm under the addition of water. After the complete amount of water had been added, the agrochemical formulation was mixed with the Ultra-Turrax device for another two minutes at 5,000 rpm.

TABLE 1
Ingredients of agrochemical formulations AA to AD in [%] w/w

| Ingredient Formulation | AA | AB | AC | AD |
|---|---|---|---|---|
| Pesticide A | 1.8 | 1.8 | 1.8 | 1.8 |
| Pesticide B | 0.9 | 0.9 | 0.9 | 0.9 |
| Pesticide C | 12 | 12 | 12 | 12 |
| Pesticide D | 7 | 7 | 7 | 7 |
| Dispersant A | 2.833 | 2.833 | 2.742 | 2.742 |
| Dispersant B | 2.833 | 2.833 | — | — |
| Dispersant C | 2.833 | 2.833 | — | — |
| Dispersant D | — | — | 5.758 | 5.758 |
| W/O-Emulsifier A | 5 | — | — | — |
| W/O-Emulsifier B | — | 5 | — | — |
| W/O-Emulsifier C | — | — | 5 | 5 |
| W/O-Emulsifier D | — | — | — | — |
| Water | 10 | 10 | 10 | 10 |
| Solvent A | up to 100 | up to 100 | up to 100 | up to 100 |

TABLE 2
Ingredients of agrochemical formulations AE to AH in [%] w/w

| Ingredient Formulation | AE | AF | AG | AH |
|---|---|---|---|---|
| Pesticide A | 1.8 | 1.8 | 2.6 | 2.6 |
| Pesticide B | 0.9 | 0.9 | 1.3 | 1.3 |
| Pesticide C | 12 | 12 | 17.31 | 17.31 |
| Pesticide D | 7 | 7 | 10.1 | 10.1 |
| Dispersant A | 2.833 | 2.833 | 2.833 | 2.833 |
| Dispersant B | 2.833 | 2.833 | 2.833 | 2.833 |
| Dispersant C | 2.833 | 2.833 | 2.833 | 2.833 |
| Dispersant D | — | — | — | — |
| W/O-Emulsifier A | — | — | — | — |
| W/O-Emulsifier B | 10 | — | 5 | — |
| W/O-Emulsifier C | — | — | — | — |
| W/O-Emulsifier D | — | 10 | — | 5 |
| Water | 15 | 15 | 5 | 5 |
| Solvent A | up to 100 | up to 100 | up to 100 | up to 100 |

### COMPARATIVE EXAMPLE 1

An oil dispersion OD-1 containing Pesticides A, B, C, D but no water droplets was prepared with the ingredients as indicated in Table 3 as follows. The first part of the solvent was mixed with the pesticides, the dispersants and the O/W-emulsifiers to a premix. Mixing was performed with a stirrer. A volume of 250 ml of the premix was then milled with a Getzmann basket mill at 4000 rpm for 2 hours at a maximum temperature of 35° C. under addition of 28 ml of zirconium oxide beads with a diameter of 1.0 to 1.2 mm. After that the remaining part of the solvent was added and the mixture was stirred to receive the final formulation OD-1.

TABLE 3
Ingredients of OD-1 in [% w/w]

| Ingredient in Formulation | OD-1 |
|---|---|
| Pesticide A | 1.8 |
| Pesticide B | 0.9 |
| Pesticide C | 12 |
| Pesticide D | 7 |
| Dispersant / OW-Emulsifier A | 2.833 |
| Dispersant / OW-Emulsifier B | 2.833 |
| Dispersant / OW-Emulsifier C | 2.833 |
| Solvent A | up to 100 |

### EXAMPLE 2: PHASE SEPARATION

The samples AE and AF and the comparative OD-1 formulation were stored at room temperature or 40° C. in transparent bottles without shaking or stirring for 7 days. Subsequently, the phase separation of the samples was analyzed. To this end, the height of the supernatant was measured and compared to the total filling height. The relative phase separation was calculated by dividing the height of the supernatant phase to the total filling height. The results are summarized in Tables 4 and 5.

TABLE 4
Relative phase separation of formulations AE, AF and
OD-1 after 7 days of incubation at room temperature.

| Formulation | AE | AF | OD-1 |
|---|---|---|---|
| Relative phase separation [%] | 0.00 | 0.00 | 17.58 |

TABLE 5
Relative phase separation of formulations AE, AF
and OD-1 after 7 days of incubation at 40° C.

| Formulation | AE | AF | OD-1 |
|---|---|---|---|
| Relative phase separation [%] | 9.20 | 0.00 | 31.10 |

### EXAMPLE 3

The herbicidal activity of the inventive formulations was assessed in comparison to commercial products and tank mixes thereof by the following greenhouse experiments:

Individual plants of LOLMU (Lolium multiflorum), ABUTH (Abutilon theophrasti), KCHSC (Kochia scoparia) and AMAPA (Amaranthus palmeri) were grown in plastic containers containing a peat based potting mix until reaching the targeted test size of 10-18 cm in height. Plants were grown separately for each species to allow for better evaluation of individual species following the herbicide treatment.

For post-emergence treatments, herbicides, which had been suspended in water, were applied using spray nozzles providing fine to coarse droplets. All treatments contained 1% (v/v) MSO surfactant. After application, the spray solution was allowed to dry, and the plants were moved to a greenhouse to allow herbicide symptoms to develop. Plants were placed in a completely randomized design with four replications per treatment. Percent injury data was collected 7, 16 and 21 days after treatment (DAT).

The evaluation for plant injury or damage caused by the chemical compositions was carried out using a scale from 0-100% when compared with the untreated control plants. Here, 0 means no damage and 100 means complete destruction of the plants.

The following herbicides were applied:
Zidua® Pro (from BASF) comprising Saflufenacil (4,81%), Imazethapyr (13.45%) and Pyroxasulfone (23.06%)
Tank mix of a) Voraxor® (from BASF) comprising Saflufenacil (21.06%) and Trifludimoxazin (10.67%), b) Pursuit® (from BASF) comprising Imazethapyr (21.6%), and c) Zidua® SC (from BASF) comprising Pyroxasulfone (41,46%)
Formulation AC according to Table 1
   3a) Control of LOLMU (Lolium multiflorum); Tables 6-8

TABLE 6

| | % control | | |
|---|---|---|---|
| a.i. appl. rate 27 g/ha | 7 DAT | 16 DAT | 21 DAT |
| Zidua ® Pro | 1 | 0 | 0 |
| Tank Mix | 17 | 13 | 8 |
| Formulation AC | 22 | 19 | 12 |

TABLE 7

| | % control | | |
|---|---|---|---|
| a.i. appl. rate 54 g/ha | 7 DAT | 16 DAT | 21 DAT |
| Zidua ® Pro | 4 | 3 | 2 |
| Tank Mix | 31 | 18 | 11 |
| Formulation AC | 33 | 25 | 15 |

TABLE 8

| | % control | | |
|---|---|---|---|
| a.i. appl. rate 108 g/ha | 7 DAT | 16 DAT | 21 DAT |
| Zidua ® Pro | 7 | 5 | 3 |
| Tank Mix | 55 | 39 | 26 |
| Formulation AC | 55 | 46 | 33 |

As seen from the data in tables 6-8, both the tank mix combination of Voraxor®, Pursuit®, and Zidua® SC and the Formulation AC provided increased LOLMU control compared to the current standard of Zidua® Pro. At all application rates LOLMU control was significantly greater with the experimental formulation and tank mix compared to the standard at 21 DAT. At the lowest application rate of 27 g ai/ha the experimental formulation AC provided significantly better LOLMU control compared to the tankmix.

3b) Control of ABUTH (Abutilon theophrasti); Tables 9-11

TABLE 9

| | % control | | |
|---|---|---|---|
| a.i. appl. rate 27 g/ha | 7 DAT | 16 DAT | 21 DAT |
| Zidua ® Pro | 33 | 26 | 16 |
| Tank Mix | 90 | 94 | 94 |
| Formulation AC | 91 | 99 | 99 |

TABLE 10

| | % control | | |
|---|---|---|---|
| a.i. appl. rate 54 g/ha | 7 DAT | 16 DAT | 21 DAT |
| Zidua ® Pro | 64 | 58 | 51 |
| Tank Mix | 96 | 97 | 98 |
| Formulation AC | 98 | 99 | 99 |

TABLE 11

| | % control | | |
|---|---|---|---|
| a.i. appl. rate 108 g/ha | 7 DAT | 16 DAT | 21 DAT |
| Zidua ® Pro | 75 | 82 | 88 |
| Tank Mix | 98 | 99 | 99 |
| Formulation AC | 99 | 99 | 99 |

As seen from the data in tables 9-11, both the tank mix combination of Voraxor®, Pursuit®, and Zidua® SC and the Formulation AC provided increased ABUTH control compared to the current standard of Zidua® Pro. At all application rates, ABUTH control at 21 DAT was significantly greater with the experimental formulation AC and tank mix compared to the standard.

3c) Control of KCHSC (Kochia scoparia); Tables 12-14

TABLE 12

| | % control | | |
|---|---|---|---|
| a.i. appl. rate 27 g/ha | 7 DAT | 16 DAT | 21 DAT |
| Zidua ® Pro | 13 | 8 | 4 |
| Tank Mix | 65 | 56 | 49 |
| Formulation AC | 76 | 68 | 60 |

TABLE 13

| | % control | | |
|---|---|---|---|
| a.i. appl. rate 54 g/ha | 7 DAT | 16 DAT | 21 DAT |
| Zidua ® Pro | 33 | 21 | 15 |
| Tank Mix | 85 | 78 | 69 |
| Formulation AC | 85 | 81 | 75 |

TABLE 14

| | % control | | |
|---|---|---|---|
| a.i. appl. rate 108 g/ha | 7 DAT | 16 DAT | 21 DAT |
| Zidua ® Pro | 30 | 21 | 15 |
| Tank Mix | 93 | 91 | 85 |
| Formulation AC | 94 | 94 | 91 |

As seen from the data in tables 12-14, both the tank mix combination of Voraxor®, Pursuit®, and Zidua® SC and the Formulation AC provided increased KCHSC control compared to the current standard of Zidua® Pro. At all application rates, KCHSC control at 21 DAT was significantly greater with the experimental formulation AC and tank mix compared to the standard.

3d) Control of AMAPA (Amaranthus palmeri): Tables 15-17

TABLE 15

| | % control | | |
|---|---|---|---|
| a.i. appl. rate 27 g/ha | 7 DAT | 16 DAT | 21 DAT |
| Zidua ® Pro | 36 | 26 | 22 |
| Tank Mix | 84 | 76 | 69 |
| Formulation AC | 93 | 88 | 82 |

TABLE 16

| | % control | | |
|---|---|---|---|
| a.i. appl. rate 54 g/ha | 7 DAT | 16 DAT | 21 DAT |
| Zidua ® Pro | 68 | 58 | 51 |
| Tank Mix | 89 | 89 | 87 |
| Formulation AC | 97 | 96 | 92 |

TABLE 17

| | % control | | |
|---|---|---|---|
| a.i. appl. rate 108 g/ha | 7 DAT | 16 DAT | 21 DAT |
| Zidua ® Pro | 66 | 48 | 44 |
| Tank Mix | 99 | 99 | 99 |
| Formulation AC | 98 | 99 | 97 |

As seen from the data in tables 15-17, both the tank mix combination of Voraxor®, Pursuit®, and Zidua® SC and the Formulation AC provided increased AMAPA control compared to the current standard of Zidua® Pro. At all application rates, AMAPA control 21 DAT was significantly greater with the experimental formulation and tank mix compared to the standard.

The greenhouse trials with different weeds show that the formulation according to the invention has at least the same or even better herbicidal activity than the corresponding tank mix. With difficult to control species such as LOLMU the herbicidal activity of the experimental formulation is better than the tank mix of the components at reduced application rates. While the differences in control between the tank mix and experimental AC formulation were not significantly different between themselves, the significant improvement over the current standard, Zidua® Pro was surprising as the total amount of PPO inhibitors applied was similar among the three formulations.

1. Agrochemical formulation comprising
f) a continuous oil phase comprising a water-immiscible solvent;
g) four agrochemical actives, Saflufenacil, Trifludimoxazin, Pyroxasulfone, and Imazethapyr, in a form of particles, which particles are suspended in the continuous oil phase;
h) a dispersant, which is an alkoxylated fatty acid ester; and
i) water droplets emulsified in the continuous oil phase;
wherein the agrochemical formulation is substantially free of a thickener.

2. The agrochemical formulation of claim 1, comprising a further dispersant, which is an ethoxylated sorbitan oleate.

3. The agrochemical formulation of claim 1, comprising a further dispersant, which is a mixture of alkoxylated fatty alcohols and alkyl-aryl-sulfonates.

4. The agrochemical formulation of claim 1, wherein a total concentration of the dispersant is at least 2 wt % based on a total weight of the agrochemical formulation.

5. The agrochemical formulation of claim 1, containing at least 1 wt % of water based on a total weight of the agrochemical formulation.

6. The agrochemical formulation of claim 1, comprising at least 1 wt % of a water-in-oil emulsifier based on a total weight of the agrochemical formulation.

7. The agrochemical formulation of claim 1, comprising at least 1 wt % of an oil-in-water emulsifier based on a total weight of the agrochemical formulation.

8. The agrochemical formulation of claim 1, wherein the continuous oil phase comprises a water-immiscible solvent selected from the group consisting of hydrocarbon solvents, vegetable oils, fatty acid esters, methyl- or ethyl esters of vegetable oils, and mixtures thereof.

9. The agrochemical formulation of claim 1 comprising the water-immiscible solvent in a concentration of from 20 to 80 wt % and the agrochemical actives in a concentration of from 1 to 60 wt %, each concentration based on a total weight of the agrochemical formulation.

10. The agrochemical formulation of claim 9, comprising 3 to 30 wt % of water droplets emulsified in the continuous oil phase, based on the total weight of the agrochemical formulation.

11. The agrochemical formulation of claim 9, wherein a total concentration of the dispersants is 5 to 15 wt %, based on a total weight of the agrochemical formulation.

12. The agrochemical formulation of claim 1, wherein the water-droplets have a mean diameter of up to 25 μm.

13. The agrochemical formulation of claim 1, comprising a thickener at a concentration of not more than 1 wt %, based on a total weight of the agrochemical formulation.

14. A method for preparing the agrochemical formulation as defined in claim 1, comprising
a) providing a premix by contacting the agrochemical actives, the dispersant, and the water-immiscible solvent;
b) milling the premix to form a raw suspension; and
c) emulsifying water in the raw suspension.

15. A method for controlling undesirable vegetation, which comprises allowing a formulation as defined in claim 1 to act on plants to be controlled or their habitat.
